(19) United States
(12) Patent Application Publication
(10) Pub. No.: US 2017/0368742 A1
(43) Pub. Date: Dec. 28, 2017

(54) CURABLE NANO-COMPOSITES FOR ADDITIVE MANUFACTURING OF LENSES

(71) Applicant: Schmutz IP, LLC, Lawrenceville, GA (US)

(72) Inventors: Daniel SLEP, Lawrenceville, GA (US); Linghui WU, Lawrenceville, GA (US)

(21) Appl. No.: 15/534,880

(22) PCT Filed: Dec. 10, 2015
(86) PCT No.: PCT/US15/65072

§ 371 Date: Jun. 9, 2017

Related U.S. Application Data
(60) Provisional application No. 62/090,610, filed on Dec. 11, 2014.

(51) Int. Cl. B29C 64/112; C08F 220/18; B33Y 70/00; B29D 11/00; G02B 1/04; C09D 4/00

(52) U.S. Cl. CPC B29C 64/112; G02B 1/041; C09D 4/00; B33Y 70/00; B29D 11/00009; C08F 220/18

(57) ABSTRACT

Curable liquid nano-composites for additive manufacturing of lenses are provided. Methods of making the curable nano-composites, and methods of additive manufacturing using the nano-composites are also provided. Additionally, objects made from additive manufacturing using the curable nano-composites are provided. In one or more embodiments, the nano-composites can contain one or more cross-linkable monomers or oligomers; a photo-initiator; and a nanoparticle. In some embodiments the curable liquid nano-composite can have a viscosity prior to curing of about 1-150 cP at room temperature and pressure The curable nano-composite can be used for additive manufacturing by printing the curable nano-composite. The printed objects can include optical lenses such as both prescription and non-prescription ophthalmic lenses.

### CROSS-REFERENCE TO RELATED APPLICATION

This application is the National Stage of International Application No. PCT/US2015/065072, filed 10 Dec. 2015, which claims the benefit of and priority to U.S. Provisional Patent Application No. 62/090,610 entitled “CURABLE NANO-COMPOSITES FOR ADDITIVE MANUFACTURING OF LENSES”, filed on 11 Dec. 2014, all of which are expressly incorporated by reference as if fully set forth herein in their entirety.

### FIELD OF THE DISCLOSURE

The present disclosure is generally in the field of composite materials for the manufacturing of lenses.

### BACKGROUND OF THE DISCLOSURE

Additive Manufacturing (AM), also known as 3D printing, has found many applications in recent years. Additive manufacturing is a process by which an object is defined three dimensionally by a series of layers. The object is then produced by creating/laying down material in rows one layer at a time.

There exist systems that use modified inkjet type technology to ‘print’ material onto a substrate, so building the object. A type of AM process utilizing ink jet print heads is described, for example, in U.S. Pat. No. 5,555,176 to Menhennett, et al. Another type of AM process which extrudes a bead of material to build a part is described, for example, in U.S. Pat. No. 5,303,141 to Batchelder et al.

Yet another type that can utilize an inkjet print head and a UV curable or photopolymer material such as described in U.S. Pat. No. 6,259,962. In this process monomers are used which polymerize by irradiation with ultraviolet light in the presence of a photo initiator.

A problem with current photopolymer materials is that for specific applications, they lack the physical properties and/or optical properties needed. Currently, when adding composite materials to photo curable materials, this usually results in nozzle clogging of the inkjet head and poor curing capabilities.

### SUMMARY

A curable liquid nano-composite for additive manufacturing of lenses is provided. In various aspects the curable liquid nano-composite includes nanoparticles. Methods of making the curable nano-composites, and methods of additive manufacturing using the nano-composites are also provided. Additionally, objects made from additive manufacturing using the curable nano-composites are provided.

In one or more embodiments, the nano-composite can contain one or more cross-linkable monomers or oligomers; a photo-initiator; and a nanoparticle. In some embodiments the curable liquid nano-composite can have a viscosity prior to curing of about 1-150 cP at room temperature and pressure The curable nano-composite can be used for additive manufacturing by printing the curable nano-composite. The printed objects can include optical lenses such as both prescription and non-prescription ophthalmic lenses. The methods can allow for precise control over the lens properties. Lenses can be formed with properties such as tint, scratch resistance, and UV protection.

The curable nano-composites can contain one or more of a variety of cross-linkable monomers. The cross-linkable monomers can be present in a combined amount from about 70-98 wt % based upon the total weight of the nano-composite. The monomers can include monoacrylates and higher order acrylates. In some embodiments the nano-composite contains higher order acrylates, e.g. di-acrylates and tri-acrylates, that are present in a combined amount from about 20-40 wt % based upon the total weight of the nano-composite.

The nano-composite can contain one or more oligomers. The one or more oligomers can be used alone without the monomer(s), can be used in combination with the monomer(s) or can be optional. An oligomer can be used with higher viscosity printing heads and can help with curing. Lower molecular weight oligomers may be preferred, for example having a molecular weight in the range of about 500 to about 5000. Suitable oligomers include molecular complexes consisting of monomer units of acrylates, methacrylates, urethanes, or methacrylate/urethanes, or combinations thereof.

The nano-composite can contain one or more nanoparticles. The nanoparticles can be organic nanoparticles or inorganic nanoparticles, typically present in an amount of about 1-25 wt % based upon the total weight of the nano-composite. The nanoparticle can have a largest diameter of about 15-200 nm. In various aspects the nanoparticle can be less than 100 nm and can be present in an amount of 10 wt % or less based upon the total weight of the nano-composite. The nanoparticle can be an organic nanoparticle, such as poly(methyl methacrylate), polycarbonate, polyethylene terephthalate, polyethylene, polypropylene, and allyl diglycol carbonate nanoparticles, high-impact polyurethane-polyurea nanoparticles, polystyrene nanoparticles, and polypropylene nanoparticles. Examples of inorganic nanoparticles can include high refractive index inorganic nanoparticles, borosilicate glass nanoparticles, titanium dioxide nanoparticles. The nanoparticles can also be sols nanoparticles, or dendritic spherical nanoparticles, or any combination of the aforementioned nanoparticles.

The curable nano-composite can include one or more photo-initiators that initiate the cross-linking Typical amounts of photo-initiator include about 1-10 wt % based upon the total weight of the nano-composite. In various aspects, the amount of the photo-initiator(s) can be 1-5 wt % based upon the total weight of the nano-composite. Commercially available photo-initiators include Omnirad 1000; Omnirad 73, Omnirad 481, Omnirad 248, Omnirad TPO, Omnirad 4817, Omnirad 4-phenyl benzophenone (4-PBZ), PHOTOMER® 4967, Irgacure 184, Irgacure 500, Irgacure 907, Irgacure 369, Irgacure 379, Irgacure 127, Irgacure 1700, Irgacure 651, Irgacure 819, Irgacure 1000, Irgacure 1300, Irgacure 1870, Darocur 1173, Darocur 2959, Darocur 4265, Darocur ITX, Lucerin TPO, Esacure KT046, Esacure KIP150, Esacure KT37, and Esacure EDB, H-Nu 470, H-Nu 470X, Genopol TX-1, and combinations thereof. The photo-initiator can be optimized to the light source used to initiate curing of the liquid nano-composite.

The nano-composite can also optionally include a polymerization inhibitor, such as phenolic antioxidants, alkylated diphenyl amines, phenyl-α-naphthylamines, phenyl-β-naphthylamines, and alkylated α-naphthylamines. The polymerization inhibitor, if present, is typically present in an amount less than about 2 wt %. The polymerization inhibitor can be added to avoid random polymerization. It can also be added to improve the shelf-life of the liquid nano-composite. Additional additives can also be included in the nano-composite such as ultraviolet (UV) absorbers, photochromic compounds, viscosity modifiers, colorants, pH adjusters, optical brighteners, and fillers.

In an embodiment, a method of additive manufacturing is provided. The method can include printing a curable nano-composite of any one or more of the foregoing aspects.

In an embodiment, a printed object is provided. The printed object can be formed by additive manufacturing with the curable nano-composite of any one or more of the foregoing aspects. The printed object can be an optical lens.

In an embodiment an optical lens is provided. The optical lens can be prepared by additive manufacturing using the curable nano-composite of any one or more of the foregoing aspects. The optical lens can be an ophthalmic lens. The optical lens can include one or more features selected from the group consisting of tint, scratch resistance, or UV protection.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### DETAILED DESCRIPTION

Curable nano-composites are provided having useful mechanical and optical properties. The curable nano-composites can be used for the additive manufacturing of a variety of optical lenses. Methods of making the curable nano-composites and methods of using the nano-composites to make a variety of optical lenses are provided. Although illustrative embodiments are described herein, those embodiments are mere exemplary implementations of the nano-composites, methods and products produced therefrom. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

Discussion

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, synthetic inorganic chemistry, analytical chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar. Standard temperature and pressure are defined as 0° C. and 1 bar.

It is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Curable Nano-Composites

Curable nano-composites are provided for additive manufacturing, e.g. by 3D printing. The term “nano-composite” is used herein to refer to any material; e.g. a solid, liquid, or dispersion; having one or more host materials into which a plurality of nanoparticles are dispersed. With regards to curable nano-composites, the term “nano-composite” can be used to refer to both the uncured precursor composite (typically a liquid or solid-in-liquid dispersion) as well as the cured composite (typically an amorphous solid). For example, the nano-composites can be prepared as a liquid or solid-in-liquid dispersion of nanoparticles where the nano-composite can be cured to form a solid having the nanoparticles dispersed therein. The curable nano-composite can be a curable resin containing the nanoparticles.

The host material can contain one or more cross-linkable monomers, or oligomers, or a combination thereof. The curable nano-composites can generally be cured by reacting the host material to form a cross-linked or network solid. A variety of methods are available for cross-linking the host materials. For example, heat, light, or chemical initiation can be used to initiate cross-linking of the host materials. In some embodiments the curable nano-composite is radiation curable, i.e. the cross-linking is initiated by one or more wavelengths of light.

Cross-Linkable Monomers

The curable nano-composite can contain one or more cross-linkable monomers. For example, the curable nano-composite can contain 2, 3, 4, 5, or more different cross-linkable monomers. The term “monomer”, as used herein, generally refers to an organic molecule that is less than 2,000 g/mol in molecular weight, less than 1,500 g/mol, less than 1,000 g/mol, less than 800 g/mol, or less than 500 g/mol. Monomers are non-polymeric and/or non-oligomeric.

The cross-linkable monomers will generally contain one or more reactive functional groups that can be reacted to form the cross-linked structure upon curing. In some embodiments the cross-linkable monomers are acrylates. The cross-linkable monomers can be monoacrylates, diacrylates, or higher acrylates that can be either substituted or unsubstituted. The cross-linkable monomers can be present in a combined amount of about 70-98 wt %, 75-95 wt %, 80-95 wt %, 80-90 wt %, or 82-97 wt % based upon the total weight of the curable nano-composite.

The curable nano-composite can contain one or more monoacrylates. Suitable monoacrylates can include, for example, 2-[2-(Vinyloxy)ethoxy]ethyl acrylate, 2-hydroxyethyl methacrylate, isodecyl acrylate, cyanoethyl methacrylate, hydroxypropyl methacrylate, p-dimethylaminoethyl methacrylate, and cyclohexyl methacrylate. The monoacrylate can be an acrylate ester of an aliphatic alcohol that can be a cycloaliphatic alcohol or a long-chain aliphatic alcohol. In some embodiments the monoacrylate is an acrylate ester of a substituted or unsubstituted alcohol having from 2-50, 5-40, 8-30, or 8-22 carbon atoms. In some embodiments the monoacrylates are present in a combined amount of about 70-98 wt %, 75-95 wt %, 80-95 wt %, 80-90 wt %, or 82-97 wt % based upon the total weight of the curable nano-composite. In some embodiments the monoacrylates are present in a combined amount of about 30-60 wt %, about 35-50 wt %, or about 35-45 wt %.

The curable nano-composite can contain one or more higher acrylates, e.g. diacrylates or triacrylates. Suitable diacrylates can include 1,4-butanediol diacrylate, 1,6-hexanediol diacrylate, neopentylglycol diacrylate, diethyleneglycol diacrylate, tetraethylene glycol diacrylate, tripropyleneglycol diacrylate, and dianol diacrylate. The diacrylate can include the acrylic acid diester of a substituted or unsubstituted di-alcohol having from 2-50, 5-40, 8-30, or 8-22 carbon atoms. Suitable triacrylates can include trimethylolpropane triacrylate, 3eo, 3po, and 5eo. In some embodiments, the diacrylates and triacrylates can be present in a combined amount of about 10-50 wt %, about 15-45 wt %, or about 20-40 wt %.

Oligomers

The curable nano-composites can contain one or more oligomers. The one or more oligomers can be present without the presence of the one or more monomers, can be present in combination with the one or more monomers or can be optional and not present at all. The term “oligomer” is used to refer to molecules having less than about 1,000 monomer repeat units, typically less than about 500, less than about 200, less than about 100 repeat units. In some embodiments the curable nano-composites contain 2, 3, 4, 5, or more different oligomers. In some embodiments the oligomer is a prepolymer of one or more of the cross-linkable monomers, e.g. the oligomer can be a monofunctional or multifunctional oligomer containing from about 2 to about 100, about 2 to about 80, about 2 to about 60, or about 5 to about 50 monomer repeat units of any cross-linkable monomer described herein. In some embodiments, when the curable nano-composite contains both monomers and oligomers, the total amount of cross-linkable monomers and oligomers can be greater than about 70 wt %, preferably greater than about 75 wt %, e.g. about 75-99 wt %, about 75-95 wt %, or about 80-90 wt %.

Photo-Initiators

The curable nano-composite contains one or more photo-initiators. The term “photo-initiator,” as the term is used herein, refers generally to any chemical species in the nanno-composite that, upon absorbing one or more wavelengths of light, initiates the cross-linking of the cross-linkable monomers and/or oligomers. For example, upon absorption of light, the photo-initiator may produce free radicals, thereby inducing polymerization of the cross-linkable compounds (monomers, oligomers or (pre)polymers) of the nano-composite. The photo-initiator is typically present in an amount less than about 15 wt %, less than about 10 wt %, typically about 1-10 wt %, about 1-5 wt %, or about 2-5 wt %.

Photo-initiators can include, but are not limited to benzophenone and substituted benzophenones; 1-hydroxycyclohexyl phenyl ketone; thioxanthones such as isopropylthioxanthone; 2-hydroxy-2-methyl-1-phenylpropan-1-one, 2-benzyl-2-dimethylamino-(4-morpholinophenyl)butan-1-one, benzil dimethylketal, bis(2,6-dimethylbenzoyl)-2,4,4-trimethylpentylphosphine oxide, 2,4,6-trimethylbenzoyldiphenylphosphine oxide, 2-methyl-1-[4-(methylthio)phenyl]-2-morpholinopropan-1-one, 2,2-dimethoxy-1,2-diphenylethan-1-one or 5,7-diiodo-3-butoxy-6-fluorone.

Commercially available photo-initiators include Omnirad 1000; Omnirad 73, Omnirad 481, Omnirad 248, Omnirad TPO, Omnirad 4817, Omnirad 4-PBZ and PHOTOMER® 4967 from IGM RESINS; Irgacure 184, Irgacure 500, Irgacure 907, Irgacure 369, Irgacure 379, Irgacure 127, Irgacure 1700, Irgacure 651, Irgacure 819, Irgacure 1000, Irgacure 1300, Irgacure 1870, Darocur 1173, Darocur 2959, Darocur 4265 and Darocur ITX available from CIBA SPECIALTY CHEMICALS; Lucerin TPO available from BASF AG; Esacure KT046, Esacure KIP150, Esacure KT37 and Esacure EDB available from LAMBERTI; H-Nu 470 and H-Nu 470X available from SPECTRA GROUP Ltd.; Genopol TX-1 from Rahn AG; and combinations thereof.

Inhibitors

The curable nano-composites may contain one or more polymerization inhibitors to control the rate of polymerization and/or prevent random polymerization. Typical polymerization inhibitors include antioxidants such as phenolic antioxidants, alkylated diphenylamines, phenyl-α-naphthylamines, phenyl-β-naphthylamines, and alkylated α-naphthylamines The polymerization inhibitors can be present at an amount less than about 5 wt %, less than about 2.5 wt %, less than about 2 wt %, or less than about 1 wt %.

Nanoparticles

The curable nano-composite can contain one or more nanoparticles. In some embodiments, the curable nano-composites can contain two, three, four, or more different nanoparticles. The nanoparticles can be organic nanoparticles or inorganic nanoparticles, e.g. the nanoparticles can be polymeric nanoparticles, metal nanoparticles, metal-oxide nanoparticles, or other nanoparticles. The nanoparticles can have any dimension necessary to achieve the desired properties. In some embodiments the nanoparticles have a greatest dimension from about 10-1,000 nm, about 10-800 nm, about 10-600 nm, about 10-500 nm, about 15-500 nm, about 15-400 nm, about 15-300 nm, about 15-200 nm, about 15-150 nm, about 20-120 nm, about 20-100 nm, or about 20-80 nm. In various aspects the nanoparticles can be less than 100 nm. The nanoparticles can be present in an amount of about 1-25 wt %, about 1-20 wt %, about 1-15 wt %, about 2-15 wt %, about 2-12 wt %, or about 2-10 wt %.

The curable nano-composite can contain one or more organic nanoparticles. The organic nanoparticles can include poly(methyl methacrylate), polycarbonate, polyethylene terephthalate, polyethylene, polystyrene and polypropylene nanoparticles, allyl diglycol carbonate nanoparticles, as well as nanoparticles made from high impact polymers such as polyurethane-polyurea materials described in U.S. Pat. No. 6,127,505 and marketed under the trade name TRIVEX®, as well as the high refractive index polymers, such as linear thioether and sulfone, cyclic thiophene, thiadiazole and thianthrene containing polymer nanoparticles.

The curable nano-composite can include one or more inorganic nanoparticles. The curable nano-composite can contain one or more high refractive index inorganic nanoparticles, e.g. TiO₂, ZrO₂, amorphous silicon, PbS, or ZnS nanoparticles. The curable nano-composite can contain inorganic nanoparticles such as borosilicate glass nanoparticles. The curable nano-composite can contain nanoparticles containing one or more metals (e.g., copper, silver, gold, iron, nickel, cobalt, indium, tin, titanium or zinc) and/or metal compounds (e.g., metal oxides, metal chalcogenides, or metal hydroxides). Examples of the metal oxides include, but are not limited to, indium oxide, tungsten oxide, tin oxide, indium tin oxide (ITO), zinc tin oxide (ZTO) ortitanium dioxide. In another embodiment, the nanoparticles may be made from one or more semiconductor materials. Examples of such semiconductor materials include, but are not limited to, silicon, silicon carbide, gallium arsenide, or indium phosphide. The nanoparticles can also be sols nanoparticles, or dendritic spherical nanoparticles, or any combination of the aforementioned nanoparticles

Additional Additives

The curable nano-composite can include one or more additional additives. Additional additives can be used, for example, to increase the hardness or scratch-resistance, to provide ultraviolet protection, or to provide coloring or tinting in the cured material. The additional additives can be present in an amount, either individually or combined, up to about 10%, 8%, 6%, or 4% by weight based upon the weight of the curable nano-composite.

The curable nano-composite can contain one or more ultraviolet absorbers. The UV inhibitors can eliminate all or most UV light and other wavelengths having a wavelength of 500 nm or less and more specifically between 300-425 nm. Typical ultraviolet absorbers include benzotriazole derivatives, benzophenone derivatives, and triazine derivatives. Ultraviolet absorbers include 2,2′-dihydroxy-4-methoxy benzophenone, 2,2′-dihydroxy-4,4′-dimethoxy benzophenone, 2,2′,4,4′-tetrahydroxy benzophenone, and mixtures thereof.

The curable nano-composite can contain one or more photochromic compounds, e.g. reversible photochromic compounds that darken when exposed to UV radiation and/or intense sunlight and revert to colorless when not irradiated. Reversible photochromic compounds are taught, for example, in U.S. Pat. Nos. 5,458,815; 5,458,814; 5,466,398 5,384,077; 5,451,344; 5,429,774; 5,411,679; 5,405,958 5,381,193; 5,369,158; 5,340,857; 5,274,132; 5,244,602 4,679,918; 4,556,605; and 4,498,919.

The curable nano-composites can include additional additives that provide various effects or facilitate storage or fabrication. Additional additives can include surfactants, viscosity modifiers, colorants, optical brighteners, pH adjusters, or fillers. The additional additives can be present in an amount, either individually or combined, up to about 10%, 8%, 6%, or 4% by weight based upon the weight of the curable nano-composite.

### Optical Lenses

The curable nano-composites described herein can be used to manufacture various optical lenses. The term “optical lens,” as used herein, refers broadly to an optical device that transmits and refracts light and can include, for example, ophthalmic lenses as well as lenses for optical instruments. The optical lens can be used in optical focusing devices such as cameras and camera accessories, telescopes, microscopes, binoculars, image projectors, and the like. Camera accessories can include lens filters, magnifiers, or reducers.

The curable nano-composites can be used to manufacture various ophthalmic lenses. Ophthalmic lenses include both corrective and non-corrective lenses. Ophthalmic lenses can include protective lenses. Ophthalmic lenses can be prescription lenses. As used herein, “prescription lenses” refers to lenses manufactured to satisfy a written order by an ophthalmologist or an optometrist to an optician for eyeglasses. It specifies the optical requirements to which the eyeglasses are to be made in order to correct blurred vision due to refractive errors, including but not limiting to myopia, hyperopia, astigmatism, and presbyopia. The term ophthalmic lens can refer to reading glasses, non-prescription sun glasses, safety glasses, driving glasses, etc. and is not limited to prescription glasses. The term ophthalmic lens can also refer to implantable lenses.

The curable nano-composites and the additive manufacturing procedures using curable nano-composites provided herein allow for precise control of the lens properties. The lenses can be made having a variety of properties such as thickness, tint, UV protection, scratch resistance, magnification, focal length, rotation, multifocal and progressive power lenses. The ability to make the lenses as needed and with fine control of the properties eliminates the need for storing a large variety of lenses; thereby eliminating the need to maintain a large inventory of various lenses at the point of sale. See U.S. Pat. No. 7,934,831.

The curable nano-composites can be used to manufacture corrective lenses. The corrective lenses will have one or more corrective features. As used herein, the term “corrective feature” refers to an aspect of the lens that corrects for eyesight deficiencies. These corrective features can include power corrections to correct for hyperopia or myopia and cylinder corrections or rotation to correct for astigmatism.

Corrective lenses can include power specifications of each lens (for each eye), typically given in units of diopter (D). Positive values indicate convergent powers that condense light to correct for farsightedness (hyperopia) or allow the patient to read more. Negative values indicated divergent powers that spread out light to correct for nearsightedness (myopia). Most people cannot distinguish between power increments less than 0.25 D, so most lens prescriptions are in 0.25 D steps. Typical prescriptions range from +4.00 D to −4.00 D. The lenses can be manufactured with any power, e.g. from about −8.00 D to +8.00 D, about −7.00 D to +7.00 D, about −6.00 D to +6.00 D, about −5.00 D to +5.00 D, about −4.50 D to about +4.50 D, about −4.00 D to about +4.50 D, or about −4.00 D to +4.00 D, in increments less than 0.5 D, 0.25 D, or 0.125 D.

Strengths are generally prescribed in quarter-diopter steps (0.25 D) because most people cannot generally distinguish between smaller increments (e.g., eighth-diopter steps/0.125 D). The power specifications for each lens can include spherical power (often denoted SPH), cylinder power (often denoted CYL), add power (often denoted ADD), and prismatic power (often denoted PRISM) as well as the axis. These terms are known in the art. The spherical power, cylinder power, add power, and prismatic power will typically be given in diopter. The axis, specifying the rotation of the meridian that contains no correction for astigmatism, is typically given in degrees. The curable nano-composites can be used to manufacture lenses that are a focal, bifocal, trifocal, or progressive.

The curable nano-composites can be used to manufacture lenses, including both corrective and non-corrective ophthalmic lenses, with additional features such as tint, scratch resistance, or UV protection. The lenses can be manufactured in this way with one or more coatings. The term “coating” is understood to mean any layer or film which may be applied during the manufacture of the lens or to the surface of an already manufactured lens, such coatings may in particular be chosen from an antireflective, antifouling, impact-resistant, scratch-resistant and polarizing coatings.

The lenses may be tinted or colored, e.g. having a degree of transmission for one or more visible wavelengths of light that is between about 10% and about 90%. The tint can be uniform or can have a gradient. The lenses can be UV protective, e.g. can include a UV absorber. UV protective refers generally to any lens that absorbs and dissipates ultraviolet radiation, in particular wavelengths from about 300-400 nm. The nano-composites can be used to make scratch-resistant lenses or scratch-resistant coatings, for example those containing acrylates or polycarbonates.

The additive manufacturing with curable nano-composites provided herein allows for precise control of the color, tint, hardness, and the refractive index of the lens. By varying the properties of the nano-composite during the manufacture, these properties can be precisely controlled at each point and within each layer during the lens manufacture.

### Methods of Making Curable Nano-Composites

The curable nano-composites described herein can be made by any method generally known to those skilled in the art. The curable nano-composites can be made by combining one or more cross-linkable monomers, one or more photo-initiators, one or more nanoparticles, and optionally one or more oligomers, one or more inhibitors, and/or one or more polymerization inhibitors. The curable nano-composites can be stored prior to use. In some embodiments the curable nano-composites are stable for more than about 3 months, 6 months, 9 months, or 1 year. The curable nano-composites can be stored in the uncured (unreacted) form. The amount of the shelf-life of the nano-composites can be controlled by including various amounts of a polymerization or cross-linker inhibitor.

### Methods of Using Curable Nano-Composites

The curable nano-composites can be used for the additive manufacturing of a variety of objects. The curable nano-composites can be used to print an object with enhanced materials strength for scratch resistance and durability and/or with enhanced optical characteristics.

One or more curable nano-composites can be used to precisely control the material properties in a layer-by-layer fashion. For example, by controlling the mixing of 2, 3, 4, or more different nano-composites during the printing the properties of the cured object can be precisely controlled in all directions.

The curable nano-composites can be printed onto a variety of substrates. In preferred embodiments the printed object is removed from the substrate after fabrication. The substrate can have a non-stick surface to prevent adhesion of the object to the substrate. The substrate can be, for example, a paper, glass, polymer, metal, or ceramic substrate.

The properties of the printed object can be controlled by changing the properties of the curable nano-composite(s) as well as by controlling the proportions of two or more nano-composites as they are mixed prior to printing. The nano-composites can be printed using a single head or a device having multiple heads. The heads may be adjusted to alter the droplet size and/or relative amounts of constituents in the nano-composites contained in the droplets.

In various aspects the head can be a jetable piezo head that can be used to deposit the curable nano-composites onto the substrate. Jetable piezo heads can provide excellent control over the position and amount of nano-composite deposited. The nano-composite droplets can be projected onto adjacent locations on the substrate so that consecutive droplets are adjoining. Such adjacent deposition preferably results in a continuous layer or film, and also tends to facilitate blending. Various droplet sizes and size distributions can be used. Droplet size is preferably selected to provide the desired gradation of properties in the resulting printed object. For example, smaller droplets tend to produce finer spatial resolution and finer control of refractive index. The volume of the nano-composite droplet can be from about 3 to 5 picoliters up to about 100 picoliters.

Another advantage of the material composition is that the nozzles will not clog during the printing process allowing better printability.

Although it is described that ultraviolet light is used to cure the material composition of the present invention used therein, it is envisioned to use other energy sources, including infrared (IR) radiation and light emitting diodes (LED), to cure the material.

### EXAMPLES

### Prophetic Example 1

An exemplary nano-composite for additive manufacturing of a lens material can be prepared having a composition according to Table 1.

TABLE 1
Composition of an exemplary nano-composite composition

| Component | Weight Percent |
|---|---|
| 2-(2-Vinyloxyethoxy)ethyl acrylate | 18% |
| Isodecyl acrylate | 27% |
| Trimethylopropane trimethacrylate | 10% |
| 1,6 hexanediol diacrylate | 30% |
| Omnirad TPO | 8% |
| PMMA nanoparticles | 7% |

The amounts of the components in the above composition can be varied. For example, the weight percentage of each component can vary ±5% or less, or ±3% or less, or ±2% or less.

Ratios, concentrations, amounts, and other numerical data may be expressed in a range format. It is to be understood that such a range format is used for convenience and brevity, and should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1% to about 5%, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figure of the numerical value. In addition, the phrase “about ‘x’ to ‘y’” includes “about ‘x’ to about ‘y’”.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A curable liquid nano-composite for use with a jetable piezo head device for additive manufacturing of lenses, the nano-composite comprising:
one or more cross-linkable monomers or oligomers;
a photo-initiator; and
a nanoparticle,
wherein the curable liquid nano-composite is configured for use in the jetable piezo head device to produce said lenses.

2. The curable liquid nano-composite of claim 1, wherein the cross-linkable monomers or oligomers are present in an amount from about 70-98 wt % based upon the total weight of the nano-composite.

3. The curable liquid nano-composite of claim 1, comprising one or more cross-linkable monomers and one or more oligomers, wherein the cross-linkable monomers and oligomers are present in a combined amount from about 70-98 wt % based upon the total weight of the nano-composite.

4. The curable liquid nano-composite of claim 1, wherein the photo-initiator is present in an amount from about 1-10 wt % based upon the total weight of the nano-composite.

5. The curable liquid nano-composite of claim 1, wherein the nanoparticle is present in an amount from about 1-25 wt % based upon the total weight of the nano-composite.

6. The curable liquid nano-composite of claim 1, wherein the cross-linkable monomers include one or more monoacrylates.

7. The curable liquid nano-composite of claim 1, wherein the cross-linkable monomers include one or more higher acrylates.

8. The curable liquid nano-composite of claim 7, wherein the higher acrylates are present in an amount from about 20-40 wt % based upon the total weight of the nano-composite.

9. The curable liquid nano-composite of claim 1, wherein the photo-intiator is selected from the group consisting of Omnirad 1000; Omnirad 73, Omnirad 481, Omnirad 248, Omnirad TPO, Omnirad 4817, Omnirad 4-PBZ, PHOTOMER®4967, Irgacure 184, Irgacure 500, Irgacure 907, Irgacure 369, Irgacure 379, Irgacure 127, Irgacure 1700, Irgacure 651, Irgacure 819, Irgacure 1000, Irgacure 1300, Irgacure 1870, Darocur 1173, Darocur 2959, Darocur 4265, Darocur ITX, Lucerin TPO, Esacure KT046, Esacure KIP150, Esacure KT37, and Esacure EDB, H-Nu 470, H-Nu 470X, Genopol TX-1, and combinations thereof.

10. The curable liquid nano-composite of claim 1, wherein the nanoparticle has a largest diameter of about 15 nm to about 200 nm.

11. (canceled)

12. The curable liquid nano-composite of claim 1, wherein the nanoparticle is an organic nanoparticle selected from the group consisting of poly(methyl methacrylate), polycarbonate, polyethylene terephthalate, polyethylene, polystyrene, polypropylene, and allyl diglycol carbonate nanoparticles, and high-impact polyurethane-polyurea nanoparticles.

13. (canceled)

14. The curable liquid nano-composite of claim 1, wherein the nanoparticle is an inorganic nanoparticle selected from the group consisting of high refractive index inorganic nanoparticles, and borosilicate glass nanoparticles.

15. (canceled)

16. The curable liquid nano-composite of claim 1, further comprising a polymerization inhibitor selected from the group consisting of phenolic antioxidants, alkylated diphenyl amines, phenyl-α-naphthylamines, phenyl-β-naphthylamines, and alkylated α-naphthylamines.

17. The curable liquid nano-composite of claim 15, wherein the polymerization inhibitor is present in an amount less than about 2 wt %.

18. The curable liquid nano-composite of claim 1, further comprising one or more additional additives selected from the group consisting of ultraviolet (UV) absorbers, photochromic compounds, viscosity modifiers, colorants, optical brighteners, pH adjusters, or fillers.

19. The curable liquid nano-composite of claim 1, wherein the liquid nano-composite has a viscosity of about 1 cP to about 150 cP at room temperature and pressure.

20. A method of additive manufacturing comprising printing a curable nano-composite of claim 1.

21. (canceled)

22. (canceled)

23. An optical lens prepared by additive manufacturing using the curable nano-composite of claim 1.

24. The optical lens of claim 23, wherein the lens is an ophthalmic lens.

25. The optical lens of claim 23, wherein the cross-linkable monomers or oligomers are present in an amount from about 70-98 wt % based upon the total weight of the nano-composite, photo-initiator is present in an amount from about 1-10 wt % based upon the total weight of the nano-composite, the nanoparticle is present in an amount from about 1-25 wt % based upon the total weight of the nano-composite and the nanoparticle has a largest diameter of about 15 nm to about 200 nm.
